(19) United States
(12) Patent Application Publication
(10) Pub. No.: US 2026/0006015 A1
(43) Pub. Date: Jan. 1, 2026

(54) SOFTWARE AS A SERVICE GEO-SPECIFIC PLATFORM

(71) Applicant: KewlStreet LLC, New York, NY (US)

(72) Inventor: Eldon Scott, New York, NY (US)

(21) Appl. No.: 19/251,263

(22) Filed: Jun. 26, 2025

Related U.S. Application Data
(60) Provisional application No. 63/664,491, filed on Jun. 26, 2024.

(51) Int. Cl. H04L 9/40

(52) U.S. Cl. CPC H04L 63/08

(57) ABSTRACT

A geocentric platform may receive a request to access a user account from a user device. The geocentric platform may verify login credentials are associated with the user account by querying one or more databases that store at least a plurality of login credentials. The geocentric platform may identify an account type associated with the user account. The geocentric platform may generate a custom user interface based on the account type, which includes one or more interactive interface elements that initiate functions based on the account type, then may present the custom user interface on a display device of the user device. The geocentric platform may receive an interaction with an element of the one or more interactive interface elements from the user device. The element may be associated with a function. The geocentric platform may initiate the function based on the interaction.

### CROSS-REFERENCE TO RELATED APPLICATIONS

The present patent application claims the benefit of U.S. Provisional Patent Application No. 63/664,491, filed Jun. 26, 2024 and entitled “Software as a Service Geo-Specific e-Commerce Platform,” which is incorporated by reference herein in its entirety.

### BACKGROUND OF THE INVENTION

### 1. Field of the Disclosure

The present disclosure is generally related to an e-commerce application, in particular relating to e-commerce within a local region.

### 2. Description of the Related Art

Small, community-oriented businesses face several disadvantages when forced to compete with e-commerce businesses, particularly when they provide equivalent or similar products or services. Despite the convenience of locally available products and services, online e-commerce platforms typically have more resources, diverse product offerings, lower prices, etc. This is often reinforced by global presence and brands which provide more efficient economies of scale and negotiating power.

Larger e-commerce businesses are further better positioned and resourced with respect to their online platforms that digitally advertise and market their products, with budgets allowing for sponsorships and preferred advertising with various platforms (e.g., social media, sports partnerships, etc.). Likewise, their scale and relationships often provide customer data and analytics which provide a distinct advantage when making business decisions and in tailoring their marketing strategies to capture market share. In an increasingly digital oriented world, small, local businesses which may have limited to no online presence can often be overlooked, particularly by tourists, despite the advantage of local geography. Likewise, they often struggle to capture local business. This often results in a customer's needs being satisfied by a large e-commerce business before considering a local agent.

There is, therefore, a need in the art for improved systems and methods of providing software-as-a-service e-commerce platforms.

### SUMMARY OF THE CLAIMED INVENTION

A geocentric platform may receive, at a processor associated with the geocentric platform, a request to access a user account from a user device. The user account may be associated with a registered user of the geocentric platform and the request may include login credentials associated with the user account. Then, the geocentric platform may verify the login credentials are associated with the user account by querying one or more databases that store at least a plurality of login credentials. Using the results of the query, the geocentric platform may identify an account type associated with the user accounts. The account type may be stored in association with the login credentials in the one or more databases. Based on the account type, the geocentric platform may generate a custom user interface. The custom user interface may include one or more interactive interface elements that initiate functions based on the account type. The geocentric platform may present the custom user interface on a display device of the user device. After presentation, the geocentric platform may receive an interaction with an element of the one or more interactive interface elements from the user device. The element may be associated with a function. The geocentric platform may initiate the function based on the interaction.

Systems and methods are described herein for a geocentric platform. The systems include one or more processors and a non-transitory computer-readable storage medium storing instructions that, when executed by the one or more processors, cause the one or more processors to perform any of the methods as previously described.

A non-transitory computer-readable medium described herein may store instructions which, when executed by one or more processors, cause the one or more processors to perform any of the methods as previously described.

These illustrative examples are mentioned not to limit or define the disclosure, by the aid understanding thereof. Additional embodiments are discussed in the Detailed Descriptions, and further description is provided there.

### BRIEF DESCRIPTION OF THE DRAWINGS

FIG. 1 illustrates a block diagram of a geocentric platform according to some aspects of the present disclosure.

FIG. 2 illustrates a block diagram of a customer portal of the geocentric platform according to some aspects of the present disclosure.

FIG. 3 illustrates a block diagram of a third-party network portal of the geocentric platform according to some aspects of the present disclosure.

FIG. 4A illustrates a block diagram of a street portal of the geocentric platform according to some aspects of the present disclosure.

FIG. 4B illustrates a block diagram of an agent manager of the street portal according to some aspects of the present disclosure.

FIG. 5 illustrates a block diagram of an administrative portal of the geocentric platform according to some aspects of the present disclosure.

FIG. 6 illustrates a block diagram of an agent portal of the geocentric platform according to some aspects of the present disclosure.

FIG. 7 illustrates a flowchart of the functionality of the geocentric platform according to some aspects of the present disclosure.

FIG. 8 illustrates a block diagram of a computing system capable of executing the functionality of the geocentric platform according to some aspects of the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

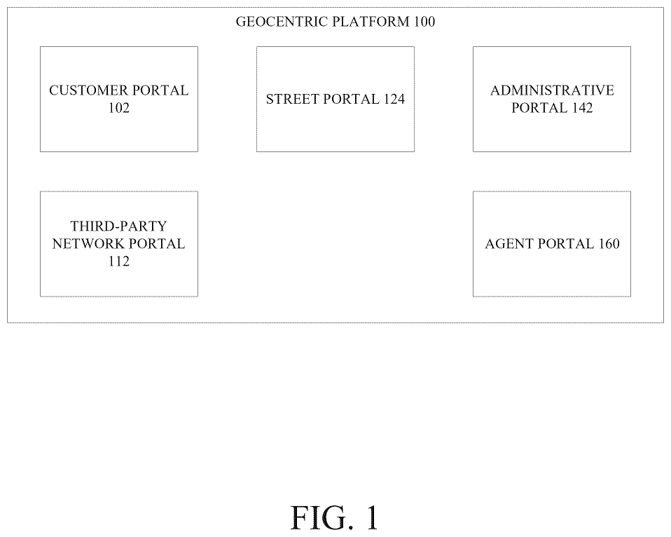

FIG. 1 illustrates a block diagram of a geocentric platform according to some aspects of the present disclosure. The geocentric platform 100 includes one or more components configured to perform the functionality of the geocentric platform 100, including, but not limited to, the customer portal 102, the third-party network portal 112, the street portal 124, the administrative portal 142, and the agent portal 160.

The geocentric platform 100 may be a platform for agents and businesses to conduct sales and transmit notifications (e.g., advertisements) between customers online. For example, a small business that does not have a strong online presence may register with the geocentric platform 100 and be equipped to conduct online sales, communicate sales to potential customers, receive business assistance from third-parties (e.g., designing advertisements, composing messaging, conducting financial transactions online, etc.), coordinate sales with other businesses (e.g., coordinating a “sidewalk sale” with other businesses in the neighborhood, offering discounts if a customer buys from more than one agent in a neighborhood, etc.), etc. In addition to agents, customers may also register with the geocentric platform 100 to gain online access to various local businesses and sales. The geocentric platform 100 also includes functionality to enable administrators of the geocentric platform 100 to manage the geocentric platform (e.g., assess finances, manage agents, view transaction histories, etc.). Further, the geocentric platform 100 includes functionality to enable third parties to coordinate with agents to draft copy, create notifications, generate branding, launch campaigns, etc.

The geocentric platform 100 may be an application accessed by a user device (e.g., a laptop, a desktop computer, a smart phone, a tablet, a smart watch, any combination thereof, or the like) that facilitates coordination and communication between users. A plurality of user devices may access distinct instances of the geocentric platform 100. For example, geocentric platform 100 may be downloaded as an application from the Internet and hosted locally, may be accessed at a remote server, may be accessed at a cloud server, may be accessed via the Internet, any combination thereof, or the like.

The user device may register with the geocentric platform 100 and request a user account associated with the geocentric platform. The user account may be customized according to a characterization of the user device. For example, the user device may be a customer device, a third-party device, a neighborhood device, an administrator device, an agent device, any combination thereof, or the like. The characterization of the user device may determine a portal that is accessible by the user device via the geocentric platform 100. For example, if the user device is characterized as an agent device, the user account may be restricted to only access and/or view the agent portal 160. The portal associated with the user device may be loaded automatically upon authentication of the user device by the geocentric platform 100 (e.g., after the user device has entered login credentials to gain access to the geocentric platform 100).

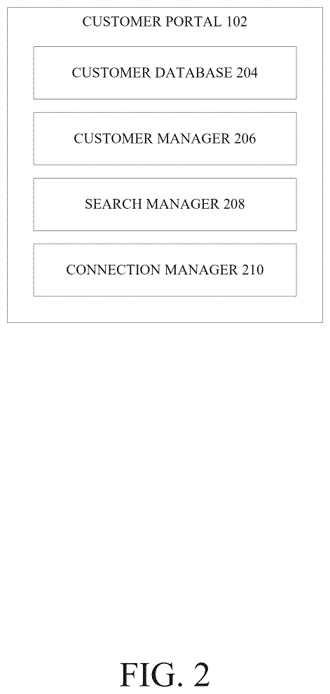

FIG. 2 illustrates a block diagram of a customer portal of the geocentric platform according to some aspects of the present disclosure. The customer portal 102 provides a customer user access to the e-commerce platform and consists of a customer database 204, customer manager 206, a search manager 208 and a connection manager 210. Through the customer portal 102, customer users can create an account, access websites, and search for businesses, goods and services, and promotions. Customers may select a geographic region such as a neighborhood, or a local region or neighborhood may be determined using methods including GPS, IP lookup, etc.

The customer database 204 is a structured set of data held in a computer consisting of at least customer information, such as but not limited to, customer name, address, login information, payment information, recent history, and current location.

The customer manager 206 controls all customer-user interactions with the e-commerce platform. For example, the customer manager 206 controls the creation of user accounts, user authentication, and other user interactions with the e-commerce platform. The customer manager 206 will further initiate the search manager 208 when the customer-user initiates a search. The search manager 208 is initiated by the customer manager 206 and takes inputs from the customer-user and uses the inputs to search the platform.

The search manager 208 is a software system that searches for and identifies items in a database that correspond to keywords or characters specified by the user. For example, a customer-user may input a search via a graphical user interface or GUI to search for a specific type of product or type of store. More specifically, the user may be looking for a coffee shop and the search manager 208 would return a list of nearby stores or shops that offer coffee. The search manager 208 may look at and return any number of results based on data from any of the systems database. Furthermore, results may be sorted in a list based on proximity to the user or a location specified by the user or based on promotions, such as putting promotions at the top the list. In some embodiments the returned results may be displayed to the user as a map to show the location of the store or businesses. In another example, a customer-user may enter a search to find a specific toy truck. The search manager 208 would search all databases and return any promotions, businesses or products related to a toy truck. Not only would the user possible products but they would also see possible promotions of similar or related products as well as a map showing the location or each search result. Searches may also include data from one or more third-party databases 314 such as from agents who are not members of the neighborhood or e-commerce platform. These search results may comprise an affiliate agent who is a member of the neighborhood who may facilitate transactions, such as by processing the sale and may additionally receive the item for pickup by a customer at the agent's business location. In alternate embodiments, the purchased item may be delivered directly to the customer's residence or other valid shipping location.

The connection manager 210 connects the customer portal 102 with the other modules within the platform. Furthermore, the connection manager 210 may also control, but not limited to, connection security, authentication (i.e., login), and secure communications and exchange of information between modules.

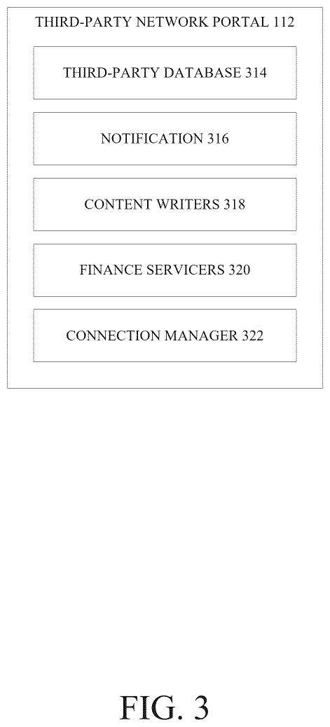

FIG. 3 illustrates a block diagram of a third-party network portal of the geocentric platform according to some aspects of the present disclosure. The third-party network portal 112 allows external data sources and users access to the e-commerce platform. The third-party network portal 112 consists of the third-party database 314, notification 316, content writers 318, financial servicers 320, connection module 322. Furthermore, the third-party network portal 112 connects to the rest of the e-commerce platform using the connection module 322, to allow third-party users such as content writers who may assist in developing advertisements or promotions to access the platform. Additionally, financial services can access the e-commerce platform through the third-party network portal 112 to provide financial access to all users across the platform and may arbitrate transactions between users.

In one embodiment, the third-party network may use an Application Programming Interface (API) in third-party websites or system, for example, it may use an API to access product and promotional details for another online e-commerce platform, or other online platforms for purchasing services or products online. In this embodiment, the API may be used to find products or services if a user can't find a product locally when searching, or alternatively to facilitate purchase of online products without local inventory via affiliate agents. Furthermore, even if local products or services are returned in a search, the third-party results or results from the API could be weighted so they fall below the local search results.

The third-party database 314 is a structured set of data held in a computer consisting of information required for the third-party network portal 112, such as but not limited to, third-party-user name, address, login information, payment information, recent history, location information, advertisement information, content writers user names and storage, and financial information.

The notification 316 are a set of notifications (e.g., advertisements) that are accessible and be used by the customer-users and businesses that are a part of the platform. In one embodiment of notification 316 the advertisements may be any marketing asset for promoting any product, service, business or group or businesses, such as but not limited to, emails, physical presences such as ads, signage, displays, etc. Furthermore, notifications 316 may provide information on how, when, and for what product or service to use them. For example, an email advertising template promoting an upcoming sidewalk sale for a group of local businesses can be used by any of the participating businesses of the sidewalk sale. The email template provides instructions to send the email to the customers of the businesses. Furthermore, the email template may provide instructions on how to add logos, and individual discounts or promotions into the email. The email template may also instruct businesses to create promotions that are specific to the sidewalk sale to help promote foot traffic. In another example, notification 316 may be a digital banner that a business can put on their website or insert into digital correspondence to customers (i.e., email). The digital banner might be a notification that links customers to a promotional or other websites.

The content writers 318 are third-party users of the e-commerce platform than can be contracted by other users of the platform to develop content for them. For example, a customer-user may need a promotion developed and may not have the skill or resources to create a promotion or notification 316. In this example the customer-user can contact a content writer 318 via the third-party network portal 112 and contract the content writer 318 develop or write a promotion or notification 316.

The financial servicers 320 consist of third-party financial software and services that can be accessed by a user of the platform to facilitate the transaction and exchange of goods and service. For example, a customer-user may require a means of completing transactions over a website whereas in the past the customer-user only dealt in person. In this case the customer-user may use financial servicers 320 to help provide online transactions and banking. The financial servicers 320 further allows businesses and their customers to complete transactions use different methods of payment. For example, a financial servicer 320 may be a bank of financial institution that allows for direct transfer of funds for a transaction. Furthermore, a financial servicer 320 may also be a provider of a digital wallet or payment system (i.e., PayPal). It would enable security online payments as well provide and escrow for some customers to pay in installments for some transactions.

The connection module 322 connects the third-party network portal 112 with the other modules within the e-commerce platform. Furthermore, the connection module 322 may also control, but not limited to, connection security, authentication (i.e., login), and secure communications and exchange of information between modules.

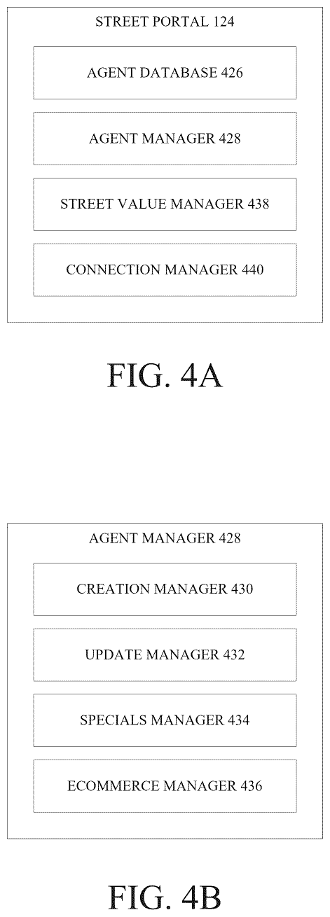

FIG. 4A illustrates a block diagram of a street portal of the geocentric platform according to some aspects of the present disclosure. The street portal 124 provides access and management of initiatives including sales, events and joint promotions at the neighborhood level and consists of the agent database 426, agent manager 428, street value manager 438, and the connection manager 440. The size, composition, and management of a neighborhood may vary based on city or location, population, and density. For example, where it might be relevant in a high-density population center to create an event or promotion and use the street portal 124 to administrate over one or two square blocks whereas the street portal 124 may be used to administrate over an entire town or city where the population density is much less. Likewise, a neighborhood may vary based upon demographics and types of businesses within the area, such as arranging based upon ethnic tradition, market vertical, such as clothing versus restaurants, etc.

The agent database 426 is a structured set of data consisting of information related to agents, business or the customer-user for the street portal 124, such as but not limited agent name, address, login information, payment information, recent history, location information, advertisement information, event information, event history, promotion information, monetization information, and financial information. Additional data may include products sold, services offered, pricing, sales statistics, etc.

FIG. 4B illustrates a block diagram of an agent manager of the street portal according to some aspects of the present disclosure.

The agent manager 428 consists of the creation manager 430, the update manager 432, the specials manager 434, and the e-commerce manager 436. The agent manager 428 allows users to create, update and administer local events, sales, promotions, joint promotions, and web sites. The agent manager 428 will allow agents or business to create and manage events based on location such as a neighborhood or a specific geo-location. The agent manager 428 also allows for the onboarding and management of other contributors to the event. For example, a contributor to an event may not be directly involved in the event but may contribute to a promotion or service when certain requirements are met. For example, a restaurant may want to contribute to the event in which they would provide a promotion such as a free dessert coupon or 50% off a meal coupon if a customer at the event spends a specific amount of money or purchases so many times during the event. Furthermore, the agent manager 428 would also allow the management of agents who would be on site at the event such as food truck or pop-up tents that would provide a service to help attract customers to the event.

The creation manager 430 is a sub-module of the agent manager 428 and is initiated by a user. The creation manager 430 is used to create new sales, events, and promotions on the e-commerce platform. When initiated the creation manager 430 will walk a user through a process to create new sales, events, and promotions.

The update manager 432 is a sub-module of the agent manager 428 and is used by a user to update or modify a sale, event, or promotion that the user created previously. For example, if a user previously created a neighborhood event for a sidewalk sale and other agents wanted to join and update discounts and promotions specific to the sidewalk sale. The specials manager 434 is a sub-module of the agent manager 428 and is used by the user to create and manage promotions and sales.

The specials manager 434 further allows the user to schedule when certain promotions are available so that the user doesn't have to constantly manage and update new sales and promotions. It also allows users to quickly activate sales or promotions and attach those sales and promotions to an event.

The e-commerce manager 436 is a sub-module of the agent manager 428 and is used to update and manage agent's online presence by managing available products, prices, and available sales or promotions. Another embodiment of the e-commerce manager 436 would allow users or agents to manage their associations or partnerships with other businesses. For example, a local agent may have a partnership with a similar agent in another region and may share promotions and sales similar products or allow for additional inventory and variety as customer buy from either store. In an embodiment, an agent within a neighborhood may be a representative of an affiliate third party agent and may offer for sale items not in the local agent's inventory but are available by the third-party agent.

Returning to FIG. 4A, the street value manager 438 handles the monetization of products, services and further can communicate with other modules of the e-commerce platform to provide payment, receive payments, or provide incentives at the local level. The street value manager 438 may further work in conjunction with other modules such as the agent manager 428 to help provide some incentives for participation in an event. For example, an agent such as a food truck maybe paid an incentive or profit-share above any profit margin for food sold. Instead of paying the food truck a flat fee to contribute to the event the food truck may be paid a percentage based on profits made by all businesses participating in the event. Furthermore, a profit-share could be established and managed by the street value manager 438 where a percentage of the profits made by businesses, agents and other contributors goes into a profit-share and at the end of the event the profit-share can be used to pay any expenses for putting on the event and shared with all participants (i.e., businesses, agents). In other embodiments, the expense for such promotions may be borne by the administrator of the e-commerce platform, funded via fees including any of subscriptions, commissions, etc.

The connection manager 440 connects the agent manager 428 with the other modules within the e-commerce platform. Furthermore, the connection manager 440 may also control, but not limited to, connection security, authentication (i.e., login), and secure communications and exchange of information between modules.

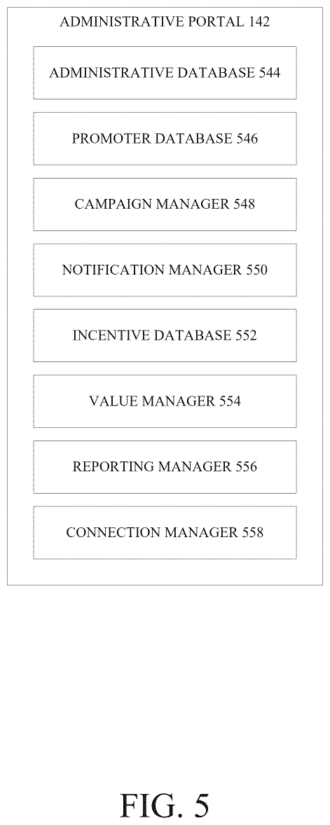

FIG. 5 illustrates a block diagram of an administrative portal of the geocentric platform according to some aspects of the present disclosure.

The administrative portal 142 is an interface that allows administrators to manage the system or service. The administrative portal 142 may have different features and settings and available features or settings may vary based on a user's permission level. The administrative portal 142 includes the administrative database 544, the promoter database 546, the campaign manager 548, the notification manager 550, the incentive database 552, the value manager 554, the reporting manager 556, and the connection manager 558.

The administrative database 544 is a structured set of data consisting of information required for the administrative portal 142, such as but not limited to, promoters' information, incentive metrics, campaign history and data, advertising information, monetization information, user information, login information, payment information, recent history, location information, and financial information.

The promoter database 546 is used to help promote the e-commerce platform to local businesses. Users or promoters use the promoter database 546 to market the platform to local businesses with the goal of getting the local businesses to sign up. The promoter database 546 then works with the incentive database 552 to incentivize the promoters for successfully signing up new businesses to the platform. In another embodiment the promoter database 546 is further used by the promoter-user to help local businesses further promote the business products, services, promotional events, and sale. For example, a promoter may be tasked with help recruit and sign-up businesses to participate in an upcoming street sales event. The promoter would use the promoter database 546 to sign up any of the local businesses who would like to participate and get them in the system. For each business the promoter signs up the promoter may get a commission via the incentive database 552, as well as additional incentives once the event has concluded. For example, for each business the promoter signs up to participate in the promoter database 546 may track sales data and the promoter may get a percentage of profits made by the business they signed up. Furthermore, if the promoter helped set up specials or promotions for businesses, they may be given an incentive if those promotions provide additional traffic and/or sales to the event.

The campaign manager 548 is used by the promoter-users to develop sales and marketing campaigns to help promote the e-commerce platform to local businesses. The campaign manager 548 can also be used to create sales or promotional campaigns to help promote events or even products for an individual business or group of businesses. The campaign manager 548 assists the promoter-user in developing and managing, but not limited to, email templates and campaigns, social media posts, and media advertisements. The campaign manager 548 would work in conjunction with the notification manager 550 to execute the scheduled advertising and promotion based on a schedule set up with the campaign manager 548. Furthermore, the campaign manager 548 may manage campaign targets or demographics that a promoter needs to hit to receive an incentive. Specifically, a promoter may have a target to sign up 5 new businesses or new business types. After a promoter signs up a new business the promoter may work with the business to set up promotions and advertisements. In one example, the promoter may help set up an email campaign to advertise an upcoming event and work with a business to create the email campaign where emails or social media posts are sent out at different intervals leading up to the event.

The notification manager 550 allows promoter-users to develop and manage notifications 316 that would be used to help promote the e-commerce platform. In one embodiment, the notification manager 550 would work independently and automatically without any need for user interaction. The notification manager 550 would initiate advertising based on database parameters and data. The notification manager 550 may further interact directly with the campaign manager 548 to schedule and deliver advertisements. For example, leading up to an event the notification manager 550 may send out template emails at a set schedule or post to social media account promoting the event. In an embodiment, the schedule may post or send out emails 3 weeks before, 1 week before, 3 days before, 1 day before and day of the event.

The incentive database 552 supports the promoter database 546 and initiates the incentive database 552. Furthermore, the incentive database 552 provides incentives to the promoters. Incentive is provided either through a set of predefined parameters such as a static percentage of sale, such as but not limited to, the number of businesses a promoter gets to sign up to the e-commerce platform, or from an event the promoter promotes, or through algorithm that calculate several incentives from several different variables (i.e., number of people who attended the event, total sales, difference in sales compared to an average day, etc.). Administrators of the platform can then update or adjust incentives per event or as needed. Furthermore, incentives may be calculated using any number of data points that are stored within the e-commerce platform. Furthermore, the promoters may receive incentives in the form of a commission, discounts to agent products, gift cards or other benefits, etc.

One example of incentives may be providing the promoter with a commission when they hit a specific target, such as signing up five new businesses to the platform over a period time. Furthermore, any new businesses signed up above the target will provide an additional incentive to the promoter and could be on a graduated scale as to provide even more incentive to the promoter to sign up more than the target. Incentives could also be calculated and provided to the promoter based on several other metrics. For example, at the event, neighborhood, or street level the promoter may receive incentives based on percentages of profits made by any businesses that they signed up that participated in an event. The more participating businesses in the event the higher a promoter's incentive would be at the end of the event. The incentive to the promoter could further be calculated if the businesses the promoter signed up to achieve a 50% increase in customers or foot traffic compared to traffic on a normal day. Additionally, promoters may be incentivized based on the level of participation pf a business they signed up. If a business just idly uses the platform there would be little or no incentive to the promoter after initially signing up the business, were as a business the leverages the platform by actively participating in events, creating promotions, and selling product or services through the platform.

The value manager 554 monitors and works with the notification manager 550. The value manager 554 can determine when a notification is used or initiated within the e-commerce platform and calculate a monetary value when the advertisement initiated. For example, a customer may receive an email or see a promotion on a website that they click on directing them to a business website. Any purchase or sale completed using the promotion by the customer will trigger the value manager 554 to store that information for later use by other modules such as but not limited to the incentive database 552. Specifically, the incentive database 552 may calculate an incentive for a promoter for each time a promotion is used for a business that they signed up. In another embodiment, the value manager 554 can further gather and calculate static for incentives and profit sharing by tying business profits to advertising and promotions. For example, the value manager 554 may compare typical average sales on a normal day for a business and compare that data to sales and profit during an event or when promotions are actively being sent out or used. Sales and profits that are calculated above a normal day could be used for profit sharing or incentives.

The reporting manager 556 generates and sends different reports. The reports can be automatically generated based on a trigger or on a schedule. The reporting manager 556 would poll for relevant data within the e-commerce platform to generate the reports. One embodiment would allow a user to create a report by selecting from preprogrammed data tokens that map or represent data in a database. The user could then generate the report manually or program a schedule when the report should trigger and generate.

The connection manager 558 connects the administrative portal 142 with the other modules within the e-commerce platform. Furthermore, the connection manager 558 may also control, but not limited to, connection security, authentication (i.e., login), and secure communications and exchange of information between modules.

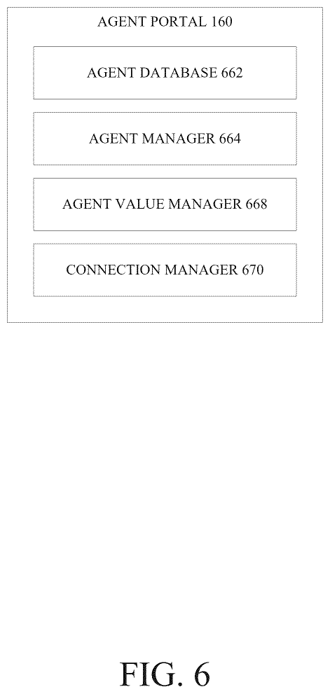

FIG. 6 illustrates a block diagram of an agent portal of the geocentric platform according to some aspects of the present disclosure. The agent portal 160 contains the agent database 662, the agent manager 664, the agent value manager 668, and the connection manager 670. The agent portal 160 allows agents to sign up, access and manage content on the e-commerce platform. The agents not only manage products and services, but also promote sales and events. It also provides the agents with a means of communicating with other agents that are registered to the platform.

The agent database 662 is a structured set of data consisting of information required for the agent portal 160, such as but not limited to, business information, products and services, inventory information, promoters' information, advertising information, incentive data and metric, monetization information, user information, login information, payment information, recent history, location information, and financial information.

The agent manager 664 allows agents to sign up, access, and manage their account on the e-commerce platform. More specifically, the agent can access the e-commerce platform after signing up and manage events, promotions, sales, products, and services, and communicate with other users and businesses on the platform. The agent manager 664 uses the connection manager 670 to communicate and access data in other modules of the e-commerce platform. Furthermore, the agent manager 664 may provide an agent with the means of creating a website that integrates with the rest of the e-commerce platform. This integration will allow an agent to share their products and services across to a wider customer base, access a system for automating promotions and advertising and integrate with other forms of payment through the financial servicer 320. In another embodiment, If the agent already has a website, the agent manager 664 may provide an API or way to connect an already established website to the platform.

The agent value manager 668 handles the monetization of products, services and further can communicate with other modules of the e-commerce platform to provide payment, receive payments, or provide incentives.

The connection manager 670 connects the agent portal 160 with the other modules within the e-commerce platform. Furthermore, the connection manager 670 may also control, but not limited to, connection security, authentication (i.e., login), secure communications, financial or payment information, and exchange of information between modules.

The functions performed in the processes and methods may be implemented in differing orders. Furthermore, the outlined steps and operations are only provided as examples, and some of the steps and operations may be optional, combined into fewer steps and operations, or expanded into additional steps and operations without detracting from the essence of the disclosed embodiments.

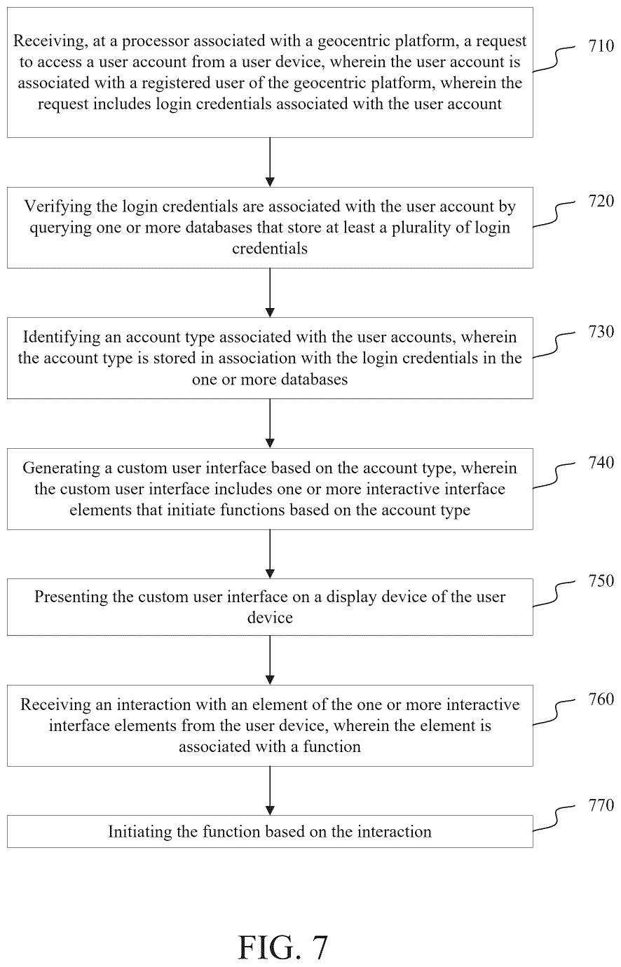

FIG. 7 illustrates a flowchart of the functionality of the geocentric platform according to some aspects of the present disclosure. The flowchart should not be construed as limiting and should instead serve as an example for the functionality of the geocentric platform. For example, the steps of the flowchart may be performed concurrently or in a different order.

At step 710, a geocentric platform receives, at a processor associated with the geocentric platform, a request to access a user account from a user device, wherein the user account is associated with a registered user of the geocentric platform, wherein the request includes login credentials associated with the user account.

At step 720, the geocentric platform verifies the login credentials are associated with the user account by querying one or more databases that store at least a plurality of login credentials.

At step 730, the geocentric platform identifies an account type associated with the user accounts, wherein the account type is stored in association with the login credentials in the one or more databases.

At step 740, the geocentric platform generates a custom user interface based on the account type, wherein the custom user interface includes one or more interactive interface elements that initiate functions based on the account type.

At step 750, the geocentric platform presents the custom user interface on a display device of the user device.

At step 760, the geocentric platform receives an interaction with an element of the one or more interactive interface elements from the user device, wherein the element is associated with a function.

At step 770, the geocentric platform initiates the function based on the interaction.

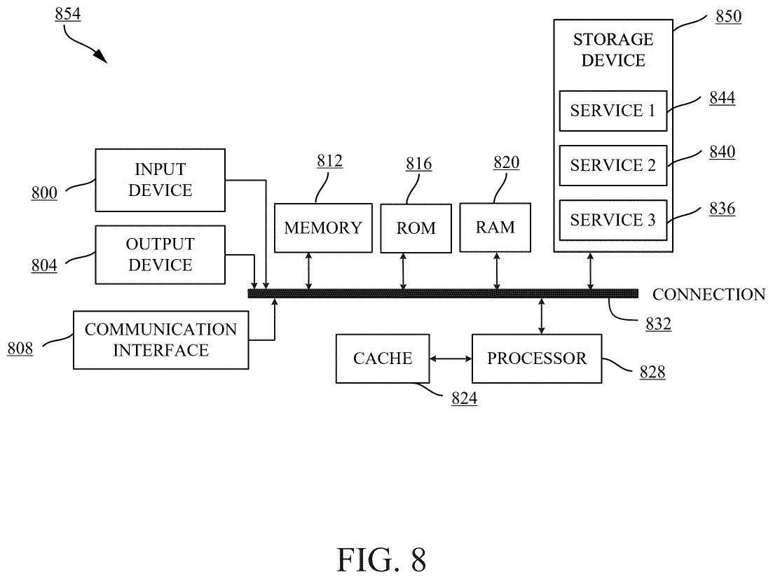

FIG. 8 illustrates an example computing device according to aspects of the present disclosure. For example, computing device 854 can implement any of the systems or methods described herein. In some instances, computing device 854 may be a component of or included within a media device. The components of computing device 854 are shown in electrical communication with each other using connection 832, such as a bus. The example computing device architecture 854 includes a processor (e.g., CPU, processor, or the like) 628 and connection 832 (e.g., such as a bus, or the like) that is configured to couple components of computing device 854 such as, but not limited to, memory 812, read only memory (ROM) 616, random access memory (RAM) 820, and/or storage device 850, to processing unit 828.

Computing device 854 can include a cache 824 of high-speed memory connected directly with, in close proximity to, or integrated within processor 828. Computing device 854 can copy data from memory 812 and/or storage device 850 to cache 824 for quicker access by processor 828. In this way, cache 824 may provide a performance boost that avoids delays while processor 828 waits for data. Alternatively, processor 828 may access data directly from memory 812, ROM 816, RAM 820, and/or storage device 850. Memory 812 can include multiple types of homogenous or heterogeneous memory (e.g., such as, but not limited to, magnetic, optical, solid-state, etc.).

Storage device 850 may include one or more non-transitory computer-readable media such as volatile and/or non-volatile memories. A non-transitory computer-readable medium can store instructions and/or data accessible by computing device 854. Non-transitory computer-readable media can include, but is not limited to magnetic cassettes, hard-disk drives (HDD), flash memory, solid state memory devices, digital versatile disks, cartridges, compact discs, random access memories (RAMs) 820, read only memory (ROM) 612, combinations thereof, or the like.

Storage device 850, may store one or more services, such as service 1 644, service 2 640, and service 3 636, that are executable by processor 828 and/or other electronic hardware. The one or more services include instructions executable by processor 828 to: perform operations such as any of the techniques, steps, processes, blocks, and/or operations described herein; control the operations of a device in communication with computing device 854; control the operations of processing unit 828 and/or any special-purpose processors; combinations therefor; or the like. Processor 828 may be a system on a chip (SOC) that includes one or more cores or processors, a bus, memories, clock, memory controller, cache, other processor components, and/or the like. A multi-core processor may be symmetric or asymmetric.

Computing device 854 may include one or more input devices 800 that may represent any number of input mechanisms, such as a microphone, a touch-sensitive screen for graphical input, keyboard, mouse, motion input, speech, media devices, sensors, combinations thereof, or the like. Computing device 854 may include one or more output devices 804 that output data to a user. Such output devices 804 may include, but are not limited to, a media device, projector, television, speakers, combinations thereof, or the like. In some instances, multimodal computing devices can enable a user to provide multiple types of input to communicate with computing device 854. Communications interface 708 may be configured to manage user input and computing device output. Communications interface 708 may also be configured to managing communications with remote devices (e.g., establishing connection, receiving/transmitting communications, etc.) over one or more communication protocols and/or over one or more communication media (e.g., wired, wireless, etc.).

Computing device 854 is not limited to the components as shown in FIG. 6. Computing device 854 may include other components not shown and/or components shown may be omitted,

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method for providing software-as-a-service e-commerce platforms, the method comprising:
receiving a request sent over a communication network from a user device to a geocentric platform server, the request concerning access to a user account of the user device and includes login credentials, wherein the user account is registered with the geocentric platform server;
verifying the login credentials are associated with the user account by querying one or more databases that store at least a plurality of login credentials;
identifying an account type corresponding to a user type of the user account, wherein the account type is stored in association with the login credentials in the one or more databases;
generating a custom user interface based on the account type, wherein the custom user interface includes one or more interactive interface elements that initiate functions based on the account type, wherein the custom user interface is generated to be presented on a display device of the user device;
receiving an interaction with an element of the one or more interactive interface elements from the user device, wherein the element is associated with a function; and
initiating the function based on the interaction.

2. The computer-implemented method of claim 1, wherein the account type is one of a customer account, a third-party account, a neighborhood account, or an administrative account.

3. The computer-implemented method of claim 1, wherein the function is a search function, and the interaction corresponds to a search query, and wherein initiating the function includes:
querying the one or more databases for at least one record that corresponds to the search query; and
generating a display of the at least one record to present on the display device of the user device.

4. The computer-implemented method of claim 1, wherein initiating the function includes:
determining that the request is a content request, wherein the content request includes a type of content and a reference to a third-party account;
transmitting a request to conduct a transaction with the third-party account; and
receiving a confirmation indicating the transaction is complete.

5. The computer-implemented method of claim 1, wherein the function includes access to a database associated with one or more agents associated with a neighborhood, including at least one of agent name, address, login information, payment information, recent history, location information, notification information, event information, and event history.

6. The computer-implemented method of claim 1, wherein the function includes initiating or modifying a neighborhood event.

7. The computer-implemented method of claim 1, wherein the function includes accessing an administrative database that includes at least one of campaign history, notification information, user information, and recent exchange history.

8. The computer-implemented method of claim 1, further comprising:
determining that the request is an account function request that includes instructions to manage an element of the user account;
modifying the element of the user account according to the instructions; and
transmitting a confirmation to the user device indicating that the element has been modified according to the instructions.

9. A system for providing software-as-a-service e-commerce platforms, the system comprising:
one or more processors; and
a communication interface that communicates over a communication network, wherein the communication interface receives a request sent over a communication network from a user device to a geocentric platform server, the request concerning access to a user account of the user device and includes login credentials, wherein the user account is registered with the geocentric platform server;
a memory that stores instructions executable by the one or more processors to:
verify the login credentials are associated with the user account by querying one or more databases that store at least a plurality of login credentials;
identify an account type corresponding to a user type of the user account, wherein the account type is stored in association with the login credentials in the one or more databases;
generate a custom user interface based on the account type, wherein the custom user interface includes one or more interactive interface elements that initiate functions based on the account type, wherein the custom user interface is generated to be presented on a display device of the user device;
receive an interaction with an element of the one or more interactive interface elements from the user device, wherein the element is associated with a function; and
initiate the function based on the interaction.

10. The system of claim 9, wherein the account type is one of a customer account, a third-party account, a neighborhood account, or an administrative account.

11. The system of claim 9, wherein the function is a search function, and the interaction corresponds to a search query, and wherein the processors initiates the function by:
querying the one or more databases for at least one record that corresponds to the search query; and
generating a display of the at least one record to present on the display device of the user device.

12. The system of claim 9, wherein the processors initiate the function by:
determining that the request is a content request, wherein the content request includes a type of content and a reference to a third-party account;
transmitting a request to conduct a transaction with the third-party account; and
receiving a confirmation indicating the transaction is complete.

13. The system of claim 9, wherein the function includes access to a database associated with one or more agents associated with a neighborhood, including at least one of agent name, address, login information, payment information, recent history, location information, notification information, event information, and event history.

14. The system of claim 9, wherein the function includes initiating or modifying a neighborhood event.

15. The system of claim 9, wherein the function includes accessing an administrative database that includes at least one of campaign history, notification information, user information, and recent exchange history.

16. The system of claim 9, wherein the processors execute further instructions to:
determine that the request is an account function request that includes instructions to manage an element of the user account; and
modify the element of the user account according to the instructions; and wherein the communication interface transmits a confirmation to the user device indicating that the element has been modified according to the instructions.

17. A non-transitory, computer-readable storage medium including instructions executable by one or more processors to perform a method for providing software-as-a-service e-commerce platforms, the method comprising:
receiving a request sent over a communication network from a user device to a geocentric platform server, the request concerning access to a user account of the user device and includes login credentials, wherein the user account is registered with the geocentric platform server;
verifying the login credentials are associated with the user account by querying one or more databases that store at least a plurality of login credentials;
identifying an account type corresponding to a user type of the user account, wherein the account type is stored in association with the login credentials in the one or more databases;
generating a custom user interface based on the account type, wherein the custom user interface includes one or more interactive interface elements that initiate functions based on the account type, wherein the custom user interface is generated to be presented on a display device of the user device;
receiving an interaction with an element of the one or more interactive interface elements from the user device, wherein the element is associated with a function; and
initiating the function based on the interaction.
